(19) United States
(12) Patent Application Publication
(10) Pub. No.: US 2006/0050717 A1
(43) Pub. Date: Mar. 9, 2006

(54) Reducing delays associated with port binding

(75) Inventors: Mallesh Lepakshaiah, Austin, TX (US); Venkat Venkatsubra, Austin, TX (US); Shantala Gopalakrishna, Austin, TX (US); Uma Krishnan, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/937,670

(22) Filed: Sep. 9, 2004

(51) Int. Cl. H04L 12/28; H04L 12/56

(52) U.S. Cl. 370/400; 370/252

(57) ABSTRACT

Methods, systems, and media to reduce delays associated with port assignments are disclosed. More specifically, embodiments include hardware and/or software to delay binding of selected port numbers to instances of applications. Some embodiments identify port numbers for which applications generate multiple bind calls that may connect with unique remote ports. The port numbers are stored in a port list that is accessible to the protocol stack and memory is allocated for storing flags and additional port configuration data. When a bind call is associated with a port number bound to another application instance and the port number is included in the port list, the bind call may then be delayed until a connect is received from the corresponding application instance. When the resulting four tuple is unique for the computer system, the corresponding application instance is bound to the port number and connected with the remote port.

### FIELD OF INVENTION

The present invention is in the field of digital communications. More particularly, the present invention relates to methods, systems, and media to reduce delays associated with binding a port to an application by delaying bind operations for selected ports.

### BACKGROUND

Personal computer systems are well known in the art. They have attained widespread use for providing computer power to many segments of today's modern society. Personal computers (PCs) may be defined as a desktop, floor standing, or portable computer that includes a system unit having a central processing unit (CPU) and associated volatile and non-volatile memory, a display, an input-output device such as a keyboard and/or a mouse, a storage device such as a hard disk storage drive, and, in many instances, a network interface adapter. One of the distinguishing characteristics of these systems is the use of a motherboard or system planar to electrically connect these components together. Examples of such personal computer systems are IBM's ThinkCentre series, ThinkPad series, and Intellistation series.

The widespread use of PCs in conjunction with networks has resulted in a reliance on the network resources, or other computer systems, for, e.g., telecommuting, obtaining news and stock market information, trading, banking, shopping, shipping, communicating in the form of Voice Internet protocol (VoiceIP) and email, as well as other services. For many, PCs represent an essential tool for their livelihood. In today's networked world, the availability and performance of the network is as important as the availability and performance of the personal computer. Thus, it is desirable to minimize loss of productivity by reducing delays associated with network resources.

Computer systems typically communicate with network resources via local area networks (LANs), such as campus-area networks (CANs) or home-area networks (HANs), or via wide area networks (WANs), such as metropolitan-area networks (MANs) or the Internet. More specifically, each computer system includes or is connected to a network switch to transmit transactions to other computer systems. Each operating system running on the multiple computer systems has its own protocol stack such as a Transmission Control Protocol/Internet Protocol (TCP/IP) stack to coordinate transmission and receipt of the transactions. For instance, when data is being transmitted out of a computer system, the data is first forwarded to the TCP/IP stack, which packages packets of the data with headers. The headers, such as Transmission Control Protocol (TCP) headers or User Datagram Protocol (UDP) headers, identify the application programs running on the local and the remote computer systems that are involved in the transaction.

Unlike TCP, which requires an acknowledgment at the receiving end (handshaking) before the session can begin, UDP just sends out packets in a one-way transmission. UDP is more efficient, for instance, in real-time audio and video transmissions in which lost packets are preferably ignored. The lost packets are preferably ignored in such situations because there is insufficient time to retransmit the packet.

The headers identify sockets for the source and destination computer system, which is a combination of (1) the computer system's IP address and (2) the application's port. If the actual IP address is unknown but the computer system is known by name, a Domain Name System server (DNS server) converts the name into the IP address. In Windows™ networks, for example, a Windows™ Internet Name System server (WINS server) converts NetBIOS names into IP addresses.

Ports are logical numbers assigned to applications that communicate with other computer systems. Some common applications like FTP, SMTP, and HTTP have agreed-upon or well-known port numbers. For example, HTTP applications accessible via the Internet such as Web servers are at port 80, so Web servers may be identified by their IP address and port 80. Other applications that are not so common may not have an agreed upon port number but an operating system, for instance, can assign port numbers to such applications as needed from a set of unassigned port numbers often called the ephemeral port range. To illustrate, an accounting application on a client computer may collect transaction information from a bank's web server. The accounting application does not have an agreed-upon port number so the client computer system assigns the next available port number. The bank's web server may be an http application so the port number for the web server is port 80 and the name of the name of the bank may be “www.banksname.org”. When the bank's web server is initiated, several instances of the web server may be executed substantially simultaneously to handle accesses from multiple clients. Each instance then generates a bind call to request port 80 for the local IP address of the bank server. Thus, each instance can service incoming connect requests from the clients. The corresponding protocol stack forwards the requests to an Application Program Interface (API) to process the bind calls and the API binds port 80 to the first instance in response to the first bind call received.

When the API receives a subsequent bind call for port 80 prior to connecting the first instance to one of the clients, the API returns an EADDRINUSE (address already in use) error code the subsequent instances. Thus, the subsequent instances of the bank's web server will have to wait a delay period, which defaults to five seconds for IBM's AIX operating systems, before the subsequent instances can initiate another bind call. If there are more than two instances requesting port number 80, this process repeats, binding one instance at a time until all but the last instance connects to a client.

The increased reliance on interaction between networked computer systems and the increased processing power of contemporary computers has made execution of multiple instances of applications such as http applications on the same server very cost effective and practical. For instance, providing an interface for each instance to share the same database, which is not always feasible when the instance are executing on different computers, reduces physical space and wiring as well as logistical problems associated with providing the updated data to each instance. However, as the number of instances being initiated in parallel increases, the delays associated with binding all the instances to the same port becomes significant, providing a practical limit to the number of such instances that can be executed simultaneously on the same computer.

One possible solution is to change the processes for binding and connecting ports to the instances of a program. Such a solution is currently infeasible because of the multitude of applications that rely on the current APIs for binding and connecting ports. Therefore, there is a need for an allocation scheme to reduce delays associated with port assignments by delaying the bind process for selected port numbers. More specifically, there is a need to reduce delays associated with binding the same port number to, e.g., instances of the same application without forcing applications to change their code for binding to a local port and connecting to a remote port.

### SUMMARY OF THE INVENTION

The problems identified above are in large part addressed by methods, systems, and media to reduce delays associated with port assignments. One embodiment provides a method for reducing delays associated with binding a local port with a local application. The method generally includes receiving a bind request to bind the local application to the local port while a second application is bound to the local port and before the second application connects with another port via the local port. The bind request is then delayed for receipt of a connect request adapted to connect the local port to a remote port. Upon receipt of the connect request, the method verifies the uniqueness of a four tuple associated with the requests to determine whether the remote port is connected with the local port and processes the bind request to connect the local port to the remote port in response verifying the uniqueness of the four tuple.

Another embodiment provides an apparatus for reducing delays associated with binding a local port with a local application. The apparatus may include a bind delayer to receive a bind request to bind the local application to the local port while a second application is bound to the local port and before the second application connects with another port via the local port. The bind delayer may also delay the bind request for a connect request to connect the local port to a remote port. The apparatus also includes a connect processor coupled with the bind delayer to verify the uniqueness of a four tuple associated with the requests to determine whether the remote port is connected with the local port; and to process the bind request to connect the local port to the remote port in response verifying the uniqueness of the four tuple.

Yet another embodiment provides a machine-accessible medium containing instructions, which when executed by a machine, cause said machine to perform operations. The operations may involve receiving a bind request to bind the local application to the local port while a second application is bound to the local port and before the second application connects with another port via the local port. The bind request is then delayed for receipt of a connect request adapted to connect the local port to a remote port. Upon receipt of the connect request, the operations verify the uniqueness of a four tuple associated with the requests to determine whether the remote port is connected with the local port and process the bind request to connect the local port to the remote port in response verifying the uniqueness of the four tuple.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an embodiment of a system including a local server and remote systems to reduce delays associated with binding a port number to instances of applications;

FIG. 2 depicts an embodiment of a five tuple, which is a synch bit packet utilized to initiate a communication channel between an application on a local server and an application on a remote computer system via Transmission Control Protocol/Internet Protocol (TCP/IP);

FIG. 3 depicts an embodiment of an apparatus to delay binding for selected port numbers to avoid more extensive delays associated with returning an “address already in use” error code;

FIG. 4 depicts an example of a flow chart for determining a list of port numbers to associate with a binding delay; and

FIG. 5 depicts an example of a flow chart to reduce delays associated with binding a port to an application.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments, but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, methods, systems, and media to reduce delays associated with binding a port to an application are contemplated. Embodiments involve a computer system having one or more applications that require a port number, or similar designation, for the purposes of communicating with a remote application. Communication with a remote application herein refers to communication with an application via a protocol stack or the like. In many embodiments, the computer system may include both the local and remote applications, and communication may be implemented via Transmission Control Protocol/Internet Protocol (TCP/IP) for a virtual local area network (LAN). In further embodiments, the computer system may include the local application(s) and associate the local application(s) with port numbers to communicate with one or more physically distinct computer systems having one or more remote applications.

Embodiments include hardware and/or software to delay binding of selected port numbers to instances of applications. Some embodiments identify a local port associated with a local application that is prone to connect to more than one remote ports via the local port. The local port is typically identified via a local port number and the local IP address but for local applications, the local port may be identified by simply the local port number. The port numbers are stored in a port list that is accessible to the protocol stack and memory is allocated for storing parameters associated with the bind calls such as flags and port configuration data. In many embodiments, the configuration data such as the parity and baud rate is included with the bind call. In one embodiment, default configuration data may be set for one or more ports in the port list.

In several embodiments, the protocol stack is adapted to delay bind requests for port numbers included in the port list. More specifically, when a bind call is associated with a port number that is already bound to another instance of an application but has not yet been connected to a remote port, the protocol stack may search the port list for the port number. When the port number is included in the port list, the protocol stack may return a code indicating a successful bind without actually transmitting the bind request to the bind API, delaying the bind for the corresponding application instance. Upon receipt of a connect request from that application instance, the protocol stack may verify that the remote port and remote address along with the local port and local address is a unique combination, uniquely identifying that application instance for communications with the remote port.

When the combination of the remote port, remote address, local port, and local address, which is referred to as a four tuple, is unique, the protocol stack proceeds to bind the local port and local address to the application instance. Then the protocol stack may process the connect request for the application instance to connect the application instance to the remote port. On the other hand, when the four tuple is not unique, the protocol stack returns an “address already in use” error code to the application instance.

Although the following detailed discussion of embodiments of the invention focus on communications via sockets APIs and Transmission Control Protocol (TCP) and/or User Datagram Protocol (UDP), other APIs and/or communications protocols that incur delays as a result of separate bind and connect requests are contemplated.

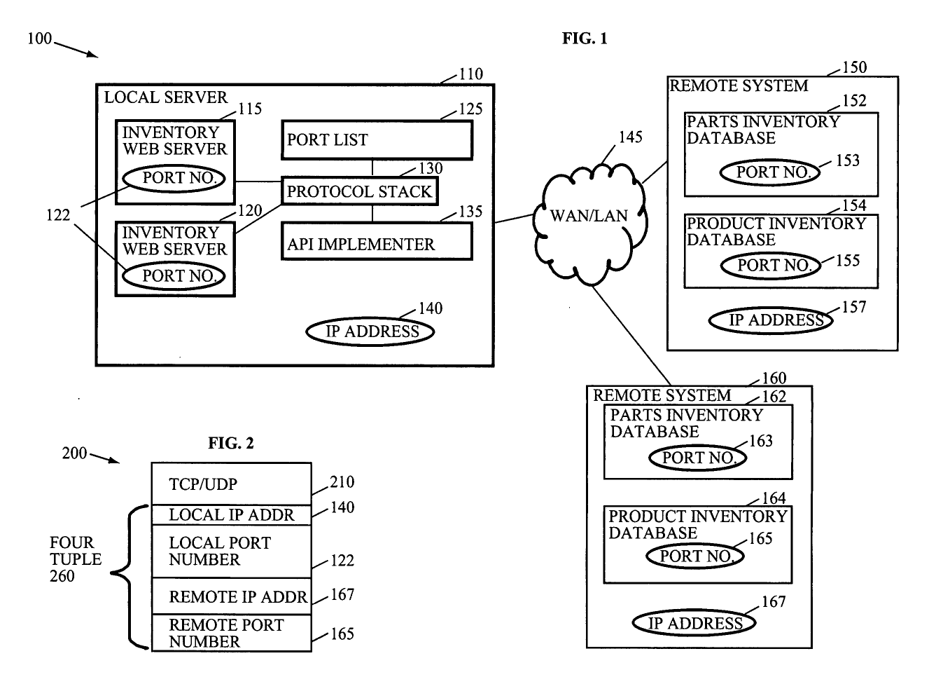

Turning now to the drawings, FIG. 1 depicts an embodiment of a system 100 to reduce delays associated with binding and connecting more than one instance of an application with remote applications. More specifically, system 100 may include a local server 110, a wide area network/local area network (WAN/LAN) 145, a remote system 150, and a remote system 160. Local server 110 may be a computer system such as for an office, an Internet provider service (ISP), or the like. In some embodiments, local server 110 may be a partition of a logically partitioned system.

Local server 110 may be adapted to execute multiple instances of an inventory web server application such as an inventory web server 115 and an inventory web server 120. The multiple application instances 115 and 120 may independently provide services to client systems such as remote system 150 and remote system 160 that communicate with local server 110 through a physical wired and/or wireless network represented by WAN/LAN 145. In further embodiments, the client systems may communicate with local server 110 via a virtual network such as a virtual LAN implemented on local server 110.

Local server 110, in the present embodiment, includes inventory web server 115, inventory web server 120, a port list 125, a protocol stack 130, and an application program interface (API) implementer 135. Inventory web server 115 may represent one instance of an application designed to periodically retrieve and/or transmit data related to part and product inventories from/to manufacturing facilities associated with remote systems 150 and 160. More specifically, inventory web servers 115 and 120 may communicate with remote system 150 six times per hour each hour and remote system 160 six times each hour to insure that the product and part inventories tracked by local server 110 accurately reflect the actual inventories at the manufacturing facilities associated with remote systems 150 and 160. In further embodiments, inventory web server 115 and/or 120 may also track part orders to analyze potential inventories.

Inventory web servers 115 and 120 may represent instances of an application that is assigned a well-known port number 122. Well-known port numbers may be numbers commonly used for a particular application or type of application such as an http application. For instance, parts inventory database 152 may periodically transmit a synch bit packet to local system 110 to initiate communication between an instance of the inventory web server application, such as inventory web server 120. The actual number assigned to port number 153 does not matter in this situation because parts inventory database 152 knows IP address 140 and the well-known port number 122. The synch bit packet may include a four tuple (a local IP address 140, well-known port number 122, a remote IP address 167 and a remote port number 165) to inform protocol stack 130 of the port number 153 and IP address 157.

FIG. 2 illustrates an example of a synch bit packet 200, which is also referred to as a five tuple. Synch bit packet 200 is designed to initiate a communication channel between an application on a local computer system such as local server 110 and an application on a remote computer system such as remote system 150 or 160. More specifically, synch bit packet 200 includes at least the information needed to establish the communication channel and synch bit packet 200, as shown, is specifically designed for TCP/IP. Synch bit packet 200 includes an indication of a protocol type 210, which may be one or more bits to describe the communication protocol requested as TCP or UDP, and a four tuple 260.

Four tuple 260, in the present embodiment, includes the socket for inventory web server 120 described by local IP address 140 and local port number 122, and the socket for product inventory database 164. The local IP address 110 uniquely identifies local server 110 on WAN/LAN 145 and local port number 122 describes inventory web server 120. Inventory web server 115 is also identified by local port number 122 so local port number does not necessarily describe inventory web server 120 uniquely but the four tuple 260, as a whole, is uniquely associated with inventory web server 120. In other words, a port number such as local port 122 can be associated with multiple active sockets so long as each active socket is associated with a unique remote socket. An active socket is a socket for which a communication channel has been established, whereas a passive socket “listens” for a connect request to establish an active socket. Only one passive socket may be established for a single IP address.

Four tuple 260 also includes an address for the remote application, remote IP address 167 and remote port number 165. Similarly, remote IP address 167 uniquely describes remote system 160 on WAN/LAN 145. Remote port number 165, on the other hand, may describe product inventory database 164 uniquely within remote system 160.

Referring again to FIG. 1, both inventory web servers 115 and 120 may request to be bound with port number 122 by transmitting bind requests, or bind calls, to protocol stack 130. For example, when local server 110 boots, the start-up sequence may initiate inventory web servers 115 and 120 substantially simultaneously to begin gathering data from remote systems 150 and 160. As a result, both inventory web servers 115 and 120 may request port number 122 at nearly the same time. Bind calls typically include at least the local port number 122. In further embodiments, the bind calls also include port parameters.

Protocol stack 130 is a set of protocols used to establish a connection or communication channel between two applications over a network such as inventory web server 115 and parts inventory database 152. Protocol stack 130 may be a hierarchy of software layers such as an application layer, transport layer, network layer, and a data link layer, designed to prepare data for transmission via a physical layer device such as a hub, router, switch, etc. and to retrieve the transmitted data from the physical layer device for an application such as inventory web server 115.

Protocol stack 130 may transmit the first bind call to API implementer 135 to bind port number 122 to the corresponding application instance and delay subsequent bind calls. For instance, when the bind call from inventory web server 115 is the first bind call to reach protocol stack 130 and the bind call from inventory web server 120 is subsequently received, protocol stack 130 may transmit the bind call for inventory web server 115 to API implementer 135 to bind port number 122 to inventory web server 115.

When protocol stack 130 receives subsequent bind calls associated with port number 122 prior to receiving a connect call for inventory application 115, protocol stack 130 may compare port number 122 against port numbers of port list 125 to determine whether the subsequent bind calls should be delayed. In particular, when multiple instances of an application are expected to request the same port number around the same time to establish connections with different remote applications, resulting in a unique four tuple, i.e., different remote IP address and port number combinations, that port number may be added to port list 125. When protocol stack 130 determines that port 122 is in port list 125, protocol stack 130 will delay binding responsive to the bind call until a connect call is received for the application instance. Thus, when protocol stack 130 receives subsequent bind calls associated with port number 122 prior to receiving a connect call from inventory application 115, the protocol stack 130 delays binding for each of the corresponding application instances.

On the other hand, if protocol stack 130 determines that the port number 122 is not in port list 125, the bind call is rejected and an “address already in use” error code is returned to the corresponding application instance. In other embodiments, more than one application may share the same port rather than, or in addition to, instances of the same application.

Upon receiving a connect call for an application instance associated with a delayed bind call, protocol stack 130 verifies that the four tuple is unique. When the four tuple is unique, the protocol stack 130 transmits the bind call for the application instance to API implementer 135 to bind that instance to local port 122. Shortly thereafter, protocol stack 130 transmits the connect call for that instance to API implementer 135 to establish a communication channel. If the four tuple is not unique, the protocol stack 130 transmits an “address already in use” error code to the corresponding application instance. Advantageously, protocol stack 130 avoids the delays involved with rejecting the bind call for the application instance when a communication channel is established.

API implementer 135 may include and coordinate the implementation of a number of APIs adapted to direct data to the appropriate application via, e.g., a TCP/IP network. For example, API implementer 135 includes code to bind local port number 122 and IP address 140 to an executing application such as inventory web server 115. As a result, when protocol stack 130 identifies a communication such as a packet directed to local port number 122 and IP address 140, protocol stack 130 processes the packet and provides data from the packet to inventory web server 115. API implementer 135 may also include code to connect the executing application to, e.g., remote port number 153 and IP address 157.

WAN/LAN 145 is a network connection to couple local server 110 with remote systems 150 and 160 to facilitate communications. In some embodiments, WAN/LAN 145 may include a network in an office coupled via Ethernet, optical media like OptiConnect, a wireless network, or the like. In several embodiments, WAN/LAN 242 also couples with the Internet via a cable modem, a digital subscriber line (DSL), a T1 line, a T3 line, or the like. In further embodiments, WAN/LAN 145 may include a network of temporary connections such as connections via a telephone system.

Remote systems 150 and 160 may be computer systems of different manufacturing facilities. Remote systems 150 and 160 may include any type of computer systems or data storage systems having a TCP/IP interface, or the like, for receiving and transmitting transactions via WAN/LAN 145. Both remote systems 150 and 160 include a parts inventory database 152, 162 and a product inventory database 154, 164. Parts inventory database 152, 162 may be one or more databases local to a manufacturing facility to track parts, available and on order, for manufacturing one or more products. Product inventory database 154, 164 may be designed to collect inventory shipments to and from the distributorship as well as bins of the products identified as being in storage at the distributorship.

Parts inventory database 152, 162 and product inventory database 154, 164 may be assigned the port numbers, 153 and 155, respectively, each time remote system 150 starts up. For instance, upon start up, parts inventory database 152 and 162 may request port numbers, 153 and 163, respectively. In some embodiments, port numbers 153 and 163 may be assigned from the ephemeral port number range and, in other embodiments, port numbers 153 and 163 may be well-known port numbers.

Parts inventory database 152, 162 and product inventory database 154, 164 may collect data locally and transmit the data, upon request, to inventory web servers 115 and/or 120 on local server 110 for analysis. In further embodiments, parts inventory database 152, 162 and product inventory database 154, 164 may automatically transmit the data rather than waiting for requests from inventory web servers 115 and/or 120.

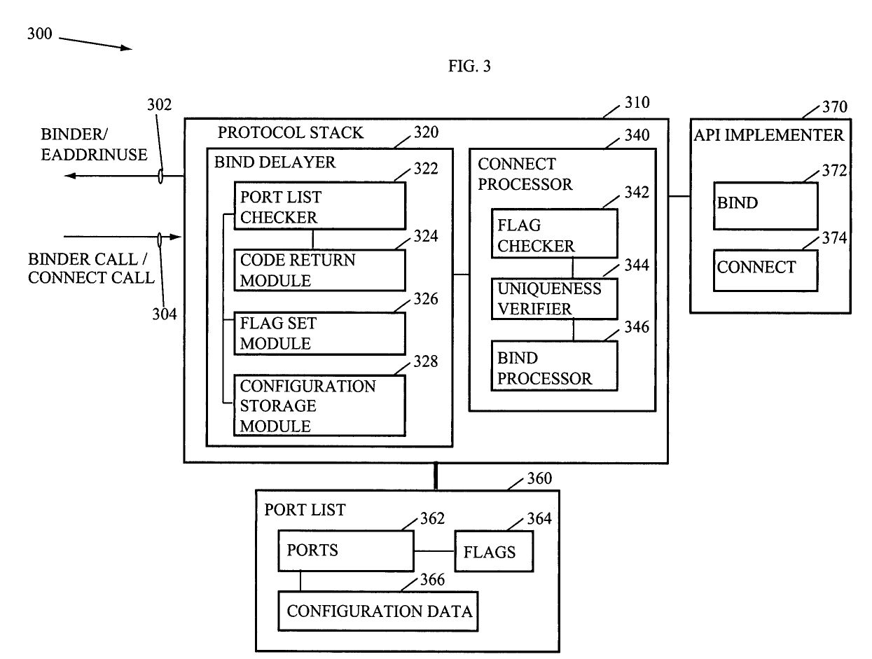

FIG. 3 depicts an embodiment of an apparatus 300 to delay binding for selected port numbers to avoid more extensive delays associated with returning an “address already in use” error code. Apparatus 300 includes a protocol stack 310, an application programming interface (API) implementer 370, and a port list 360. Protocol stack 310 may receive bind calls and connect calls 304 from applications to establish a communications channel with another application via a network protocol such as a TCP/IP protocol. For instance, protocol stack 310 may receive bind call 304 from an application requesting assignment of a port number which is the same port number requested by other instances of the application. When the bind call is received after receipt of a bind call from another instance of the application but before receipt of a connect call for that other instance, protocol stack 310 may not bind the port to the instance in response to the bind call. Instead, protocol stack 310 may delay binding until after receipt of a connect call for that other instance.

Protocol stack 310 includes a bind delayer 320 and a connect processor 340. Bind delayer 320 may select bind calls to delay and delay processing of the selected bind calls. Bind delayer 320 includes a port list checker 322, a code return module 324, a flag set module 326, and a configuration storage module 328. Port list checker 322 is adapted to communicate with port list 360 to determine whether a bind call should be delayed. In particular, port list checker 322 compares the port number associated with the bind call with a list of port numbers, ports 362, in port list 360. In many embodiments, if the port number is included in port list 360, protocol stack 310 should anticipate a unique four tuple for the communication channel to be established for the corresponding instance and, thus, bind delayer 320 may delay processing of the bind call. If the port number is not in ports 362, an EADDRINUSE 302 (“address in use”) error code is returned to the corresponding instance.

When the port number is included in the list, port list checker 322 communicates with code return module 324 to return a code, referred to as a binder 302. Binder 302 indicates the binding is successful even though the bind call is being delayed to provide the corresponding instance with the anticipated response. In some embodiments, if the application does not need to receive a code indicating a successful bind when the bind is delayed, code return module 324 may not return binder 302. In further embodiments, port list 360 may include an indication regarding whether a code should be returned to an instance and code return module 324 may communicate with port list 360 to determine whether to return a binder 302.

In the present embodiment, port list checker 322 instructs flag set module 326 to set a flag associated with the port number of a delayed bind call to indicate that a bind call associated with the port number is being delayed. Port list checker 322 also instructs configuration storage module 328 to store parameters associated with the bind call in configuration data 366.

Flag set module 328 may set flags associated with instances for which binding is being delayed. More specifically, flag set module 326 may couple with port list 360 to store one or more bits, or a flag, at a memory location of flags 364 to indicate that the bind call is being delayed.

Configuration storage module 328 may interact with port list checker 322 to determine when the parameters associated with a bind call should be stored in configuration data 366. In some embodiments, configuration storage module 366 includes an index pointer that associates the configuration data 366 entry with a flag in flags 364. In further embodiments, flags 364 may include a pointer to associate a flag with parameters stored in configuration data 366.

Connect processor 340 is designed to process connect calls. More specifically, connect processor 340 transmits a connect call to API implementer 370 to establish a communication channel between two applications over a network. When connect processor 340 is processing a connect call associated with a delayed bind call, connect processor 340 processes the delayed bind call if the four tuple associated with the bind call and connect call is unique. Connect processor 340 includes a flag checker 342, a uniqueness verifier 344, and a bind processor 346.

Flag checker 342 communicates with port list 360 upon receipt of a connect call for a port number to determine whether a bind call associated with the port number has been delayed. If so, flag checker 342 instructs uniqueness verifier 344 to determine whether the four tuple associated with the bind call and connect call is unique. For example, uniqueness verifier 344 may look up the parameters associated with the bind call in configuration data 366 and compare the local port number, remote port number and remote address with four tuples of other, established communications channels. In some embodiments, uniqueness verifier 344 may only compare the remote port number and remote IP address associated with the connect call against the remote port numbers and addresses associated with other instances of the same application.

If the four tuple is not unique, protocol stack 310 may return an EADDRINUSE 302 error code to the corresponding instance. On the other hand, when the four tuple is unique, bind processor 346 may gather the parameters associated with a delayed bind call from configuration data 366 and transmit the bind call to API implementer 370. Then, connect processor 340 may transmit the corresponding connect call to API implementer 370 to establish the communication channel.

Port list 360 includes memory allocated for maintaining ports 362, flags 364, and configuration data 366. In many embodiments, port list 360 may include non-volatile memory to maintain ports 362. In further embodiments, port list 360 includes volatile memory to store flags 364 and configuration data 366. In one embodiment, ports 362 may be copied from non-volatile memory to volatile memory to facilitate faster access to the corresponding port numbers.

Ports 362 may include a list of port numbers. In some embodiments, ports 362 may also include additional information such as an indication of the application that may request binding to the port number via multiple instances.

Flags 364 may be a queue, buffer, cache, or the like. Flags 364 may include one or more bits associated with each bind call delayed by protocol stack 310. Further, the one or more bits may also be associated with data stored in configuration data 366.

Configuration data 366 may include parameters for one or more delayed bind calls. For instance, configuration data 366 may store a local port number as well as data describing parameters of the communication channel to establish for the port such as a polling mode, a baud rate, a number of stop bits, a number of data bits, a parity mode, a duplex mode, and the like.

API implementer 370 is a networking interface such as the Sockets networking interface developed for UNIX. Current Sockets networking interfaces include, for example, WinSockets™ and Berkley Sockets. Sockets may be active or passive. Bind 372 is an API adapted to establish active and passive sockets. API implementer 370 establishes a passive socket by implementing a listen API after execution of bind 372. API implementer 370 implements connect 374 after execution of bind 372 to establish an active socket, which is a communication channel in the Sockets networking environment. In particular, when bind 372 binds a port to an instance, the socket may become an active socket or a passive socket depending upon whether API implementer 370 executes a listen API or connect 374.

Upon receipt of a connect call, connect 374 connects the local socket with a socket of a remote application to establish a communication channel. The sockets associated with the communication channel are referred to as active sockets. Connect 374 may establish more than one active socket with a particular port and IP address at the same time so long as the remote ports, i.e., the combinations of the remote port numbers with remote IP addresses, are unique.

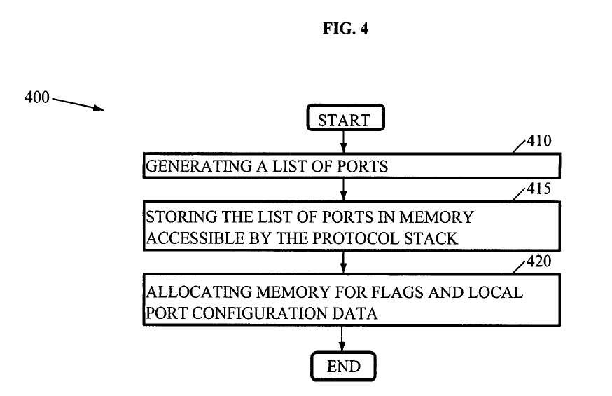

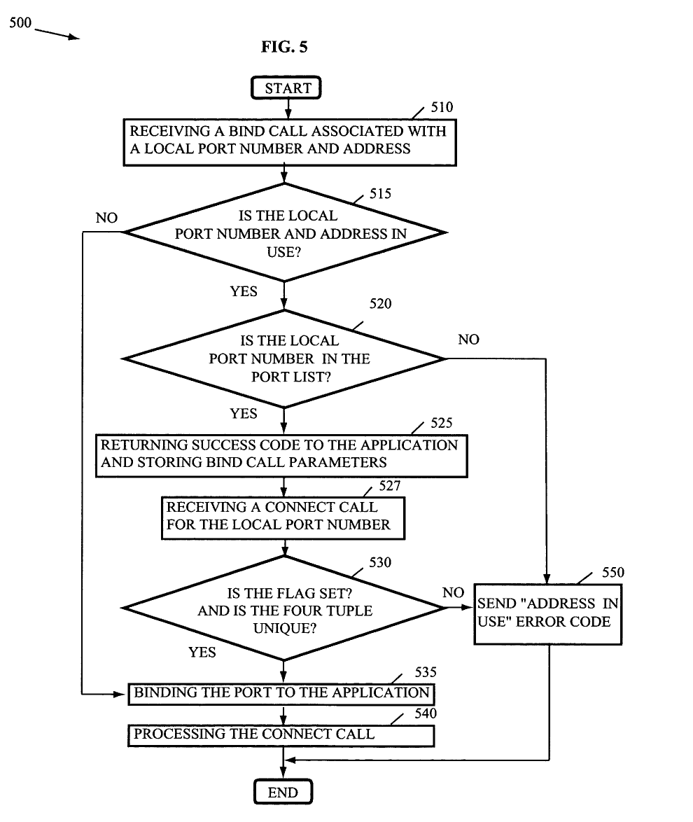

Referring now to FIG. 4, there is shown an example of a flow chart 400 for determining a list of port numbers to associate with delayed binding. Flow chart 400 begins with generating a list of ports (element 410). In particular, port numbers to be associated with applications are identified if multiple, unique, active sockets are anticipated for the application.

After generating the list of ports, the list is stored in non-volatile memory that is accessible by the protocol stack (element 415). In further embodiments, the list of ports may be stored in volatile memory rather than non-volatile memory and generated again if the list is lost for any reason. For example, a server may be designed to run for, e.g., 19 years without having to restart. Thus, the list of port numbers generated at the start up for the server may be valid while the server remains operational. However, certain circumstances such as software updates to critical systems may force the server to restart. At restart, the list of ports, or a portion thereof may be reconfigured for the new and/or updated software. For example, the configuration data may reside in flash memory having initial program loads (IPLs) for system startup.

Memory allocations provide storage for flags and parameters associated with the delayed bind calls such as flags and port configuration data (element 420). In many embodiments, memory allocations for flags and parameters are made from volatile memory such as random access memory (RAM).

Referring now to FIG. 5, there is shown an example of a flow chart 500 to reduce delays associated with binding a port to an application. Flow chart 500 begins with receipt of a bind call associated with a local port number and address (element 510). In particular, a local application such as a File Transfer Protocol (FTP) server may receive multiple requests for file transfers substantially simultaneously. The FTP server may be one of a few servers available to provide updates for commonly used software such as Lotus Notes™ over a TCP/IP network (Internet, Unix, etc.). As a result, several instances of the FTP protocol server may be initiated substantially simultaneously and each instance may initiate a bind call to request that the instance be bound to the local port number such as 20.

At decision element 515, the protocol stack determines whether another instance is bound to the port number and still listening for a connection from one of the FTP clients. If no other instance bound to the port number is still listening for a connect call, the protocol stack transmits the request to an API implementer to bind the port to the application instance (element 535). Then, a communication channel is established in response to a connect call for the local port number such as 20 (element 540).

On the other hand, when another instance is bound to the port number and is listening for a connection, the protocol stack determines whether the port number is in the port list (element 520). If the port number is not in the port list, a return code is transmitted to the application instance to indicate that the address is already in use (element 550). However, if the port number is in the port list (element 520), a code is returned to the application instance and the data or parameters associated with the bind call are stored in memory accessible to the protocol stack (element 525).

After the application instance is bound to the port, the protocol stack may receive a connect call requesting that the port number, e.g., for the FTP server, be connected to a remote port number and address (element 527). For instance, an FTP client may provide the remote port number bound to the FTP client at a remote IP address in the connect call.

Upon receipt of the connect call, the protocol stack may check to see if a flag is set for the port number indicating that a bind for the port number has been delayed and if so, the protocol stack verifies that the four tuple created by the local port number and address and the remote port number and address are unique (element 530). If the four tuple is not verified as being unique, an error code is returned to the application instance to indicate that the address is already in use (element 550).

On the other hand, when the four tuple is unique, the protocol stack gathers the parameters or configuration data for the delayed bind and transmits the bind request to the API implementer to bind the local port number to the application instance (element 535). Then, the protocol stack forwards the connect call to the API implementer to establish a communication channel between the application instance and the remote application at the remote port number and address (element 540).

One embodiment of the invention is implemented as a program product for use with a computer system such as, for example, the system 100 shown in FIG. 1. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., hard-disk drive or floppy disks within a diskette drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates sub-division of an ephemeral port range and allocation ports from the sub-divisions based upon, e.g., application loads, anticipated and/or actual load conditions, quality of service, performance guarantees, application starvation, process priority, user identifications, group identifications, process names, and/or the like. It is understood that the form of the invention shown and described in the detailed description and the drawings are to be taken merely as examples. It is intended that the following claims be interpreted broadly to embrace all the variations of the example embodiments disclosed.

What is claimed is:

1. A method for reducing delays associated with binding a local port with a local application, the method comprising:
receiving a bind request to bind the local application to the local port while a second application is bound to the local port and before the second application connects with another port via the local port;
delaying the bind request for a connect request, the connect request being a request to connect the local port to a remote port;
verifying the uniqueness of a four tuple associated with the requests to determine whether the remote port is connected with the local port; and
processing the bind request to connect the local port to the remote port in response verifying the uniqueness of the four tuple.

2. The method of claim 1, further comprising processing the connect request to connect the local port with the remote port to establish a communication channel between the local application and a remote application.

3. The method of claim 1, further comprising:
determining that the local application is prone to connect to more than one remote ports via the local port and
storing a port number for the local port in a port list.

4. The method of claim 2, further comprising comparing the local port to the port list upon receipt of the bind request to determine whether to delay the bind request.

5. The method of claim 1, wherein delaying comprises setting a flag to indicate that the bind request is delayed.

6. The method of claim 1, wherein delaying comprises storing parameters associated with the bind request to implement the bind request in response to the connect request.

7. The method of claim 1, wherein delaying comprises returning a code in response to the bind request to indicate that the bind request is successful.

8. The method of claim 1, wherein verifying comprises determining that the combination of the local port and the remote port identifies a unique communication channel.

9. The method of claim 1, wherein processing the bind request comprises executing the bind request via an application program interface (API).

10. An apparatus for reducing delays associated with binding a local port with a local application, the apparatus comprising:
a bind delayer to receive a bind request to bind the local application to the local port while a second application is bound to the local port and before the second application connects with another port via the local port; and to delay the bind request for a connect request, the connect request being a request to connect the local port to a remote port; and
a connect processor coupled with the bind delayer to verify the uniqueness of a four tuple associated with the requests to determine whether the remote port is connected with the local port; and to process the bind request to connect the local port to the remote port in response verifying the uniqueness of the four tuple.

11. The apparatus of claim 10, further comprising a port list having a port number associated with the local port to indicate that the local application is prone to connect to more than one remote ports via the local port.

12. The apparatus of claim 10, further comprising an application program interface (API) implementer to execute the bind request.

13. The apparatus of claim 10, wherein the bind delayer is adapted to compare the local port to the port list upon receipt of the bind request to determine whether to delay the bind request.

14. The apparatus of claim 10, wherein the bind delayer comprises a configuration storage module to store parameters associated with the bind request to implement the bind request in response to the connect request.

15. The apparatus of claim 10, wherein the connect processor is adapted to process the connect request to connect the local port with the remote port to establish a communication channel between the local application and a remote application.

16. The apparatus of claim 10, wherein verifying comprises determining that the combination of the local port and the remote port identifies a unique communication channel.

17. A machine-accessible medium containing instructions, which when executed by a machine, cause said machine to perform operations, comprising:
receiving a bind request to bind a local application to a local port while a second application is bound to the local port and before the second application connects with another port via the local port;
delaying the bind request for a connect request, the connect request being a request to connect the local port to a remote port;
verifying the uniqueness of a four tuple associated with the requests to determine whether the remote port is connected with the local port; and
processing the bind request to connect the local port to the remote port in response verifying the uniqueness of the four tuple.

18. The machine-accessible medium of claim 17, wherein the operations further comprise processing the connect request to connect the local port with the remote port to establish a communication channel between the local application and a remote application.

19. The machine-accessible medium of claim 17, wherein the operations further comprise:
determining that the local application is prone to connect to more than one remote ports via the local port and
storing a port number for the local port in a port list.

20. The machine-accessible medium of claim 19, wherein the operations further comprise comparing the local port to the port list upon receipt of the bind request to determine whether to delay the bind request.
